(19) United States
(12) Patent Application Publication
(10) Pub. No.: US 2019/0331102 A1
(43) Pub. Date: Oct. 31, 2019

(54) ELECTRO HYDRO DYNAMIC APPARATUS AND SYSTEM COMPRISING AN ELECTRO HYDRO DYNAMIC APPARATUS

(71) Applicant: Huawei Technologies Co., Ltd., Shenzhen (CN)

(72) Inventor: Niklas LEKSELIUS, Kista (SE)

(21) Appl. No.: 16/506,652

(22) Filed: Jul. 9, 2019

Related U.S. Application Data
(63) Continuation of application No. PCT/EP2017/050301, filed on Jan. 9, 2017.

(51) Int. Cl. F04B 19/00; H02K 44/04; F28F 13/06

(52) U.S. Cl. CPC F04B 19/006; F28F 13/06; H02K 44/04

(57) ABSTRACT

Herein an electro hydro dynamic, EHD, apparatus (2) is disclosed. The EHD apparatus comprises a first electrode (4) and a second electrode (6). The second electrode (6) is arranged above the first electrode (4) at a predetermined distance for generating an airflow. The second electrode (6) comprises at least one electrode element (10, 12). The at least one electrode element (10, 12) comprises a gap (18) extending along a length of the at least one electrode element (10, 12) for capillary conducting water droplets along the at least one electrode element (10, 12).

### CROSS-REFERENCE TO RELATED APPLICATIONS

This application is a continuation application of international patent application number PCT/EP2017/050301, filed on Jan. 9, 2017, the disclosure of which is hereby incorporated by reference in its entirety.

### TECHNICAL FIELD

The invention relates to an electro hydro dynamic, EHD, apparatus and to a system comprising an electro hydro dynamic, EHD, apparatus.

### BACKGROUND

An Electro Hydro Dynamic, EHD, device is configured to generate airflow utilising ionised air. A high voltage is applied between two electrodes, which forms an electric field. The electric field ionises air. The ionised air is drawn towards one of the electrodes and is thus, accelerated. The accelerated air passes the one electrode and forms the airflow. Such an airflow may be utilised for cooling heat generating equipment. In such case an Electro Hydro Dynamic, EHD, cooling device may be referred to.

US 2016079840 discloses an Electro Hydro Dynamic, EHD, thruster comprising a first set of electrodes, a second set of electrodes, and a supporting structure for supporting the first set of electrodes and the second set of electrodes. The EHD thruster is configured to generate airflow of ionised air for cooling a heat sink. It is proposed that the EHD thruster is utilised to move air across the surface of the heat sink instead of utilising a rotating fan. The EHD thruster has no moving or rotating parts. A reliable and silent cooling mechanism is achieved for providing high capacity cooling of the heat sink. By keeping the EHD thruster electrically isolated from the heat sink, the risk of an accident is reduced. The heat sink may be thermally coupled to a power amplifier of a Remote Radio Unit, RRU.

The voltage between the electrodes of an EHD apparatus is close to the level for an electrical breakdown through the air between the electrodes. Accordingly, an EHD apparatus is dependent on a correct distance between the two electrodes in order to properly ionise air. If the EHD apparatus is used in an environment where water droplets may be present, such droplets may deposit on one or both electrodes reducing the electrical distance there between causing an electrical breakdown, which may take the form of an electric spark or an electric arc.

### SUMMARY

It is an object of the invention to prevent the forming of water droplets on at least one of the electrodes of an electro hydro dynamic, EHD, apparatus.

According to an aspect of the invention, the object is achieved by an electro hydro dynamic, EHD, apparatus, comprising a first electrode and a second electrode, wherein the second electrode is arranged above the first electrode at a predetermined distance for generating an airflow. The second electrode comprises at least one electrode element. The at least one electrode element comprises a gap extending along a length of the at least one electrode element for capillary conducting water droplets along the at least one electrode element.

Since the at least one electrode element of the second electrode comprises a gap extending along a length of the at least one electrode element for capillary conducting water droplets along the at least one electrode element, water droplets are prevented from depositing on the at least one electrode element in a manner which would shorten an electrical distance between the first and second electrodes. Instead, water is conducted in the gap along the at least one electrode element, to an area of the second electrode where the water may be drained from the second electrode without causing electrical breakdown. As a result, the above mentioned object is achieved. Moreover, the EHD apparatus is thus, suited for use in humid environments where water droplets may form on the second electrode, or in environments where water droplets may be present, such as outdoors.

The electro hydro dynamic, EHD, apparatus is configured for generating the airflow utilising ionised air between the first and second electrodes. In use of the EHD apparatus, a high voltage is applied between the first and second electrodes, forming an electric field between the two electrodes. The electric field ionises the air in between the electrodes. The ionised air is drawn towards the second electrode and thus, accelerates air in between the two electrodes. The accelerated air passes the second electrode and forms the airflow. The first and second electrodes may comprise a conductive material, such as e.g. a metal.

According to embodiments, the at least one electrode element may comprise a through slit forming the gap. In this manner, the gap may be easily manufactured, e.g. in a laser cutting operation.

According to embodiments, the at least one electrode element may comprise two separate members forming there between the gap. In this manner, the gap may be provided by positioning two separate members at a suitable distance from each other.

According to embodiments, the first electrode and the second electrode may extend along a first direction and the at least one electrode element may extend along a second direction across the first direction and wherein at least a portion of the gap may have a width in the first direction within a range of 0.1-0.5 mm. In this manner, a gap width suitable for providing capillary action on water droplets may be provided.

According to embodiments, the gap may widen towards at least one end of the gap. In this manner, the capillary action on the water in the gap may be reduced at the wide end of the gap. Thus, water may be drained from the wide end of the gap. Accordingly, water droplets may continuously or intermittently be drawn into the gap by the capillary action of the gap, and the water droplets may continuously or intermittently be drained at the wide end of the gap. The wide end of the gap may suitably be arranged at a distance from the first electrode such that the electrical distance between the first and second electrodes is not shortened by the water being drained from the wide end of the gap.

According to embodiments, the at least one electrode element may comprise at least a first electrode portion configured to be arranged at a first angle to a horizontal plane. In this manner, gravity may assist water in the gap to flow along the first electrode portion in the gap.

According to embodiments, the at least one electrode element may comprise a first electrode portion and a second electrode portion, and wherein the first and second electrode portions may be arranged at an obtuse angle to each other with a vertex of the obtuse angle pointing away from the first electrode. In this manner, gravity may assist water in the gap to flow along also the second electrode portion in the gap. The provision of the first and second electrode portions being arranged at the obtuse angle provide for the first and second electrode portions being symmetrically arranged in relation to the first electrode.

According to embodiments, the gap may widen towards a low end of the gap. In this manner, gravity may assist water in the gap to flow towards the wide end of the gap where the water is drained from the gap.

According to embodiments, the first electrode may comprise at least one protrusion extending in a direction towards the second electrode, setting a predetermined distance between the first and second electrodes for forming an electric field between the first and second electrodes configured to generate the airflow utilising ionised air. In this manner, the at least one protrusion may provide a well-defined portion of the first electrode where the electric field between the first and second electrodes will have its highest value.

According to embodiments, the second electrode may comprise a first electrode element and a second electrode element, wherein the first and second electrode elements may be arranged with an interspace there between for permitting the airflow to pass through the second electrode. In this manner, the electric field between the first and second electrodes may have the highest value at each of the first and second electrode elements for ionising air to generate the airflow during use of the EHD apparatus. The generated airflow may pass the second electrode through the interspace between the first and second electrode elements.

It is a further object of the invention to provide a system for outdoor use comprising an EHD apparatus, wherein the forming of water droplets on at least one of the electrodes of the EHD apparatus is prevented.

According to an aspect of the invention, the object is achieved by a system comprising heat generating electronic components, a heat sink thermally connected to the heat generating electronic components, and an electro hydro dynamic, EHD, apparatus according to any one of aspects and/or embodiments discussed herein arranged to generate an airflow in a flow direction along and/or through the heat sink. In this manner, the EHD apparatus directly cools the heat sink and indirectly cools the heat generating electronic components. Thus, the EHD apparatus forms an electoral hydrodynamic, EHD, cooling device of the system. Moreover, since the at least one electrode element of the second electrode comprises a gap extending along a length of the at least one electrode element, as discussed above, water droplets are prevented from depositing on the at least one electrode element. Thus, the system is suited for outdoor use where water droplets may be present. As a result, the above mentioned object is achieved.

The heat generating electronic components may for instance comprise a power amplifier of a Remote Radio Unit, RRU. Since the heat sink is thermally coupled to the power amplifier, the power amplifier may be indirectly cooled by the EHD apparatus.

According to embodiments, the heat sink may comprise a first heat sink part and a second heat sink part, and a compartment for holding the EHD apparatus for providing a push airflow in the flow direction along and/or through the first heat sink part and a pull airflow along and/or through the second heat sink part. In this manner, the airflow on both sides of the EHD apparatus may be utilised for providing the airflow a long and/or through both the first and second heat sink parts.

According to embodiments, the EHD apparatus may be open in the flow direction for enabling natural convection cooling of the heat sink. In this manner, cooling of the heat sink by natural convection is not obstructed by the EHD apparatus when the EHD apparatus is switched off.

Further features of, and advantages with, the invention will become apparent when studying the appended claims and the following detailed description.

### BRIEF DESCRIPTION OF THE DRAWINGS

Various aspects and/or embodiments of the invention, including its particular features and advantages, will be readily understood from the example embodiments discussed in the following detailed description and the accompanying drawings, in which:

FIGS. 1a and 1b illustrate schematically cross sections through an electro hydro dynamic apparatus,

FIGS. 2a-2d illustrate an example of an electro hydro dynamic apparatus,

FIGS. 3a and 3b illustrate examples of schematically portions of second electrodes,

FIGS. 4a-4c illustrate an another example of an electro hydro dynamic apparatus, and

FIG. 5 illustrates an example of a system comprising an electro hydro dynamic apparatus.

### DETAILED DESCRIPTION

Aspects and/or embodiments of the invention will now be described more fully. Like numbers refer to like elements throughout. Well-known functions or constructions will not necessarily be described in detail for brevity and/or clarity.

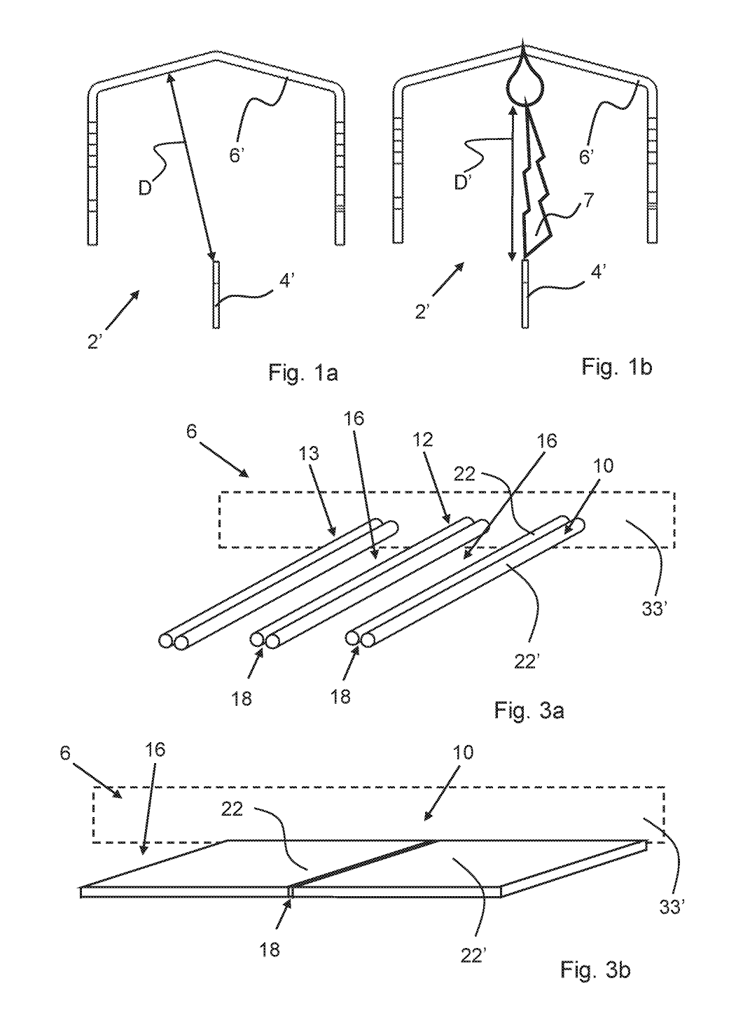

FIGS. 1a and 1b illustrate schematically cross sections through an electro hydro dynamic, EHD, apparatus 2′. A high voltage is applied over a first electrode 4′ and a second electrode 6′. The electrical distance D between the first and second electrodes 4′, 6′ is the shortest distance between the first and second electrodes 4′, 6′. For the EHD apparatus 2′ to be efficient, the electrical distance D should be as short as possible in relation to the applied voltage between the first and second electrodes 4′, 6′ without causing electrical breakdown.

A water droplet 5 hanging from a lower side of the second electrode 6′may shorten the original electrical distance D to a different electrical distance D′ short enough to cause electrical breakdown, as indicated with the electric arc 7 in Fig. lb. Accordingly, the forming of water droplets in critical areas of the upper electrode is to be avoided.

The inventor has realised that capillary action may be utilised for preventing formation of water droplets on the upper electrode large enough for, and/or in places, causing electrical breakdown in the EHD apparatus. The use of capillary action is a cost efficient and reliable way of preventing the forming of water droplets on the electrode of the EHD apparatus.

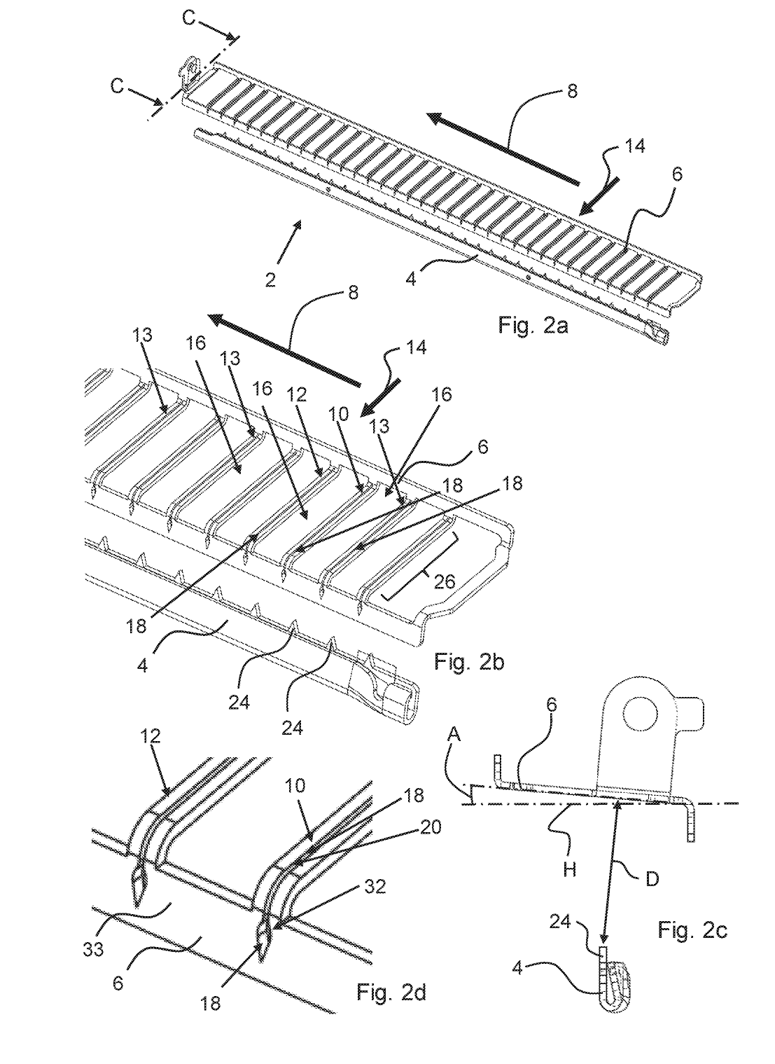

FIGS. 2a-2d illustrate an example of an electro hydro dynamic, EHD, apparatus 2. FIG. 2a illustrates a view of the EHD apparatus 2, FIG. 2b illustrates a partial enlargement of the EHD apparatus 2, FIG. 2c illustrates a view along lines C-C in FIG. 2a, and FIG. 2d illustrates a partial enlargement of a second electrode 6 of the EHD apparatus 2. The EHD apparatus 2 comprises a first electrode 4 and the second electrode 6. The first and second electrodes 4, 6 may be arranged in a holding structure, not shown. The holding structure electrically isolates the first electrode 4 from the second electrode 6. The second electrode 6 is arranged above the first electrode 4. The first electrode 4 may be considered a high voltage emitter, and the second electrode 6 may form a grounded collector grid. During use of the EHD apparatus 2, the voltage applied over the first and second electrodes 4, 6 is very close to the voltage resulting in electrical breakdown between the first and second electrodes 4, 6. The high voltage forms an electric field which ionises the air in between the first and second electrodes 4, 6, which generates an airflow in a direction from the first electrode 4 towards the second electrode 6. Mentioned purely as an example, the voltage between the first and second electrodes 4, 6 may be within a range of 7-15 kV.

The second electrode 6 comprises at least one electrode element 10, 12. In particular, the second electrode 6 may comprise a first electrode element 10 and a second electrode element 12. More specifically, the second electrode may comprise a number of electrode elements 10, 12, 13. The electrode elements 10, 12, 13 are arranged with an interspace 16 between pairs of the electrode elements 10, 12, 13. During use of the EHD apparatus 2 the airflow is permitted to pass through the interspaces 16. Thus, the airflow is permitted to pass through the second electrode 6. Moreover, water droplets falling from above the second electrode 6 may fall through the interspaces 16, and the EHD apparatus 2 without affecting the function of the EHD apparatus 2.

The at least one electrode element 10, 12, and suitably each electrode element of the number of electrode elements 10, 12, 13, comprises a gap 18 extending along a length of the relevant electrode element 10, 12, 13. Water droplets depositing on the relevant electrode element 10, 12, 13 are drawn into the gap 18 by capillary action. Thus, the water droplets may be capillary conducted along the relevant electrode element 10, 12, 13 and electrical breakdown, otherwise caused by the water droplets, may be avoided.

The gap 18 in each of the electrode elements 10, 12, 13 may be formed by a through slit 20.

The second electrode 6 may be made from metal. Mentioned purely as an example, the second electrode 6 may be manufactured from sheet metal, such as e.g. stainless steel sheet metal. The sheet metal may have a thickness within a range of 0.3-5.0 mm. The second electrode 6 may be formed from sheet metal e.g. by punching, cutting, or laser cutting, and bending or pressing. The slit 20 in each electrode element 10, 12, 13 may e.g. be cut in a laser cutting operation. Similarly, the first electrode 4 may be manufactured from the same type of material and using the same manufacturing methods as the second electrode 6.

The first electrode 4 and the second electrode 6 extend along a first direction 8. The at least one electrode element 10, 12 extends along a second direction 14 across the first direction 8. In these embodiments the second direction 14 extends perpendicularly to the first direction 8. However, the second direction 14 may extend at a different angle across the first direction 8, such as at e.g. a 45° angle.

The width of the gap 18 may be within a range of 0.1-0.5 mm. More specifically, at least a portion of the gap 18 may have a width in the first direction 8 within a range of 0.1-0.5 mm. According to some embodiments the gap 18 may have a width within a range of 0.2-0.3 mm.

The gap 18 widens towards one end 32 of the gap 18. For instance, the one end 32 of the gap 18 may be one or more millimetres wide. The one end 32 of the gap 18 may also be referred to as the wide end 32 of the gap 18. The capillary action on any water in the gap 18 is reduced at the wide end 32 of the gap 18, and water may be drained from the gap 18 at its wide end 32. The wide end 32 of the gap 18 may be arranged within the electrode element 10, 12. Alternatively, and as illustrated in FIGS. 2b and 2d, the wide end 32 of the gap 18 may be arranged a common portion 33 of the second electrode 6, to which common portion 33 the electrode elements 10, 12 connect.

Each of the electrode elements 10, 12, 13 comprise a first electrode portion 26 configured to be arranged at a first angle A to a horizontal plane H, when the EHD apparatus 2 is in use. Thus, gravity may assist water in the gap 18 to flow along the first electrode portion 26 in the gap 18, towards a low end of the gap 18. At the low end of the gap 18 the wide end 32 of the gap 18 may drain the gap 18 from water. However, alternatively the gap 18 may simply extend all the way through the common portion 33 thus, forming a drainage opening at a lower end of the second electrode 6.

As mentioned above, the first electrode 4 extends in the first direction 8. Perpendicularly to the first direction 8 an extension of the first electrode 4 is limited, e.g. in the order of the 1-10 mm. Thus, the airflow passes the first electrode 4 without being hindered by the first electrode 4 to any larger extent. The first electrode 4 comprises one protrusion 24, extending in a direction towards the second electrode 6, for each electrode element 10, 12, 13. Between one protrusions 24 and a corresponding electrode element 10, 12, 13 a predetermined distance is set. The predetermined distance suitably forms the electrical distance D between the first and second electrodes 4, 6 of the EHD apparatus 2. Thus, the electric field between the first and second electrodes 4, 6 has its highest values in positions having the electrical distance D there between. Mentioned purely as an example, the electrical distance D may be e.g. 15 mm. The voltage applied between the first and second electrodes 4, 6 may in such case be approximately 15 kV.

FIG. 3a illustrates schematically a portion of a second electrode 6 as an alternative example. Each of the electrode elements 10, 12, 13 comprises two separate members 22, 22′ forming there between the gap 18. Again, the gap 18 has a width such that water will be drawn into the gap 18 by capillary action. In these embodiments, each of the two separate members 22, 22′ comprises a rod. The separate members 22, 22′ are connected to a common portion 33′ of the second electrode 6. Similarly, a further common portion (not shown) may be connected to the opposite ends of the separate members 22, 22′. Interspaces 16 for passage of an airflow are formed between the electrode elements 10, 12, 13.

FIG. 3b illustrates schematically a portion of a second electrode 6 as another example. Again, the electrode elements 10 comprise two separate members 22, 22′ forming there between the gap 18. In FIG. 3b only one of the electrode elements 10 is shown. Again, the gap 18 has a width such that water will be drawn into the gap 18 by capillary action. In these embodiments, each of the two separate members 22, 22′ comprises a flat member. Again, the separate members 22, 22′ are connected to a common potion 33′ of the second electrode 6. Interspaces 16 for passage of an airflow are formed between the electrode elements 10. In FIG. 3b one of the interspaces is indicated adjacent to one of the separate members 22.

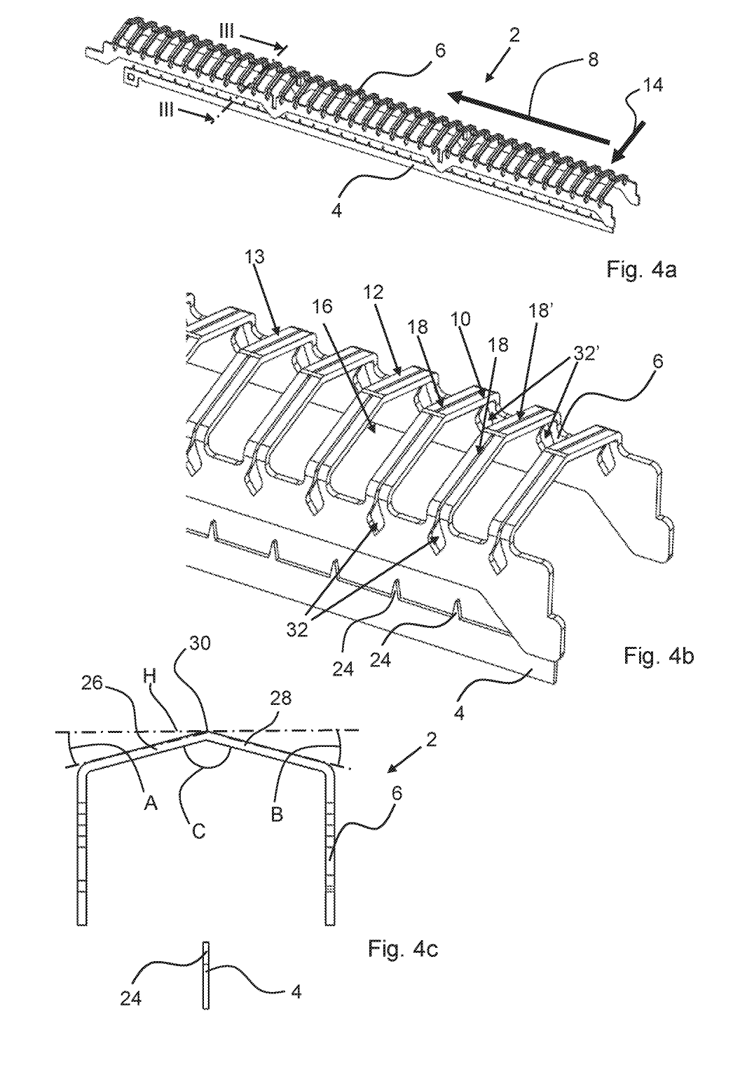

FIGS. 4a-4c illustrate another example of an electro hydro dynamic, EHD, apparatus 2. FIG. 4a illustrates a view of the EHD apparatus 2, FIG. 4b illustrates a partial enlargement of the EHD apparatus 2, and FIG. 4c illustrates a cross section along lines III-III in FIG. 4a. These embodiments resemble in much the embodiments of FIGS. 2a-2d. Accordingly, in the following mainly the differences to the embodiments of FIGS. 2a-2d will be discussed.

Again, the EHD apparatus 2 comprises a first electrode 4 and the second electrode 6 extending along a first direction 8. The second electrode 6 comprises at least one electrode element 10, 12, 13. The first electrode 4 comprises one protrusion 24, extending in a direction towards the second electrode 6, for each electrode element 10, 12, 13. The electrode elements 10, 12, 13 are arranged with an interspace 16 between pairs of the electrode elements 10, 12, 13. The at least one electrode element 10, 12 comprises a gap 18 extending along a length of the at least one electrode element 10, 12. The at least one electrode element 10, 12 extends along a second direction 14 across the first direction 8.

Again, each of the electrode elements 10, 12 comprises a first electrode portion 26 which may be arranged at a first angle A to a horizontal plane H, when the EHD apparatus 2 is in use.

In these embodiments, each of the electrode elements 10, 12 comprises a second electrode portion 28 which may be arranged at a second angle B to the horizontal plane H, when the EHD apparatus 2 is in use. The first and second electrode portions 26, 28 are arranged at an obtuse angle C to each other with a vertex 30 of the obtuse angle C pointing away from the first electrode 4. The first and second electrode portions 26, 28 being arranged in this manner provide for gravity to assist water in the gap 18 to flow along the first and second electrode portions 26, 28 in the gap 18, towards respective low ends of the gap 18.

The gap 18 may form one gap which extends along both the first and second electrode portions 26, 28. Alternatively, each of the first and second electrode portions 26, 28 may be provided with one gap 18, 18′.

The gap 18 widens towards both ends 32, 32′ of the gap 18, if the gap 18 extends along both the first and second electrode portions 26, 28. If each of the first and second portions 26, 28 are provided with one gap 18, 18′, one end 32, 32′ of each gap 18, 18′ widens. The gap 18 widens towards one or both low ends 32, 32′. Thus, the capillary action on any water in the gap 18 is reduced at the low positioned wide end/s 32, 32′ of the gap 18, and water may be drained from the gap 18 at its wide end/s 32, 32′.

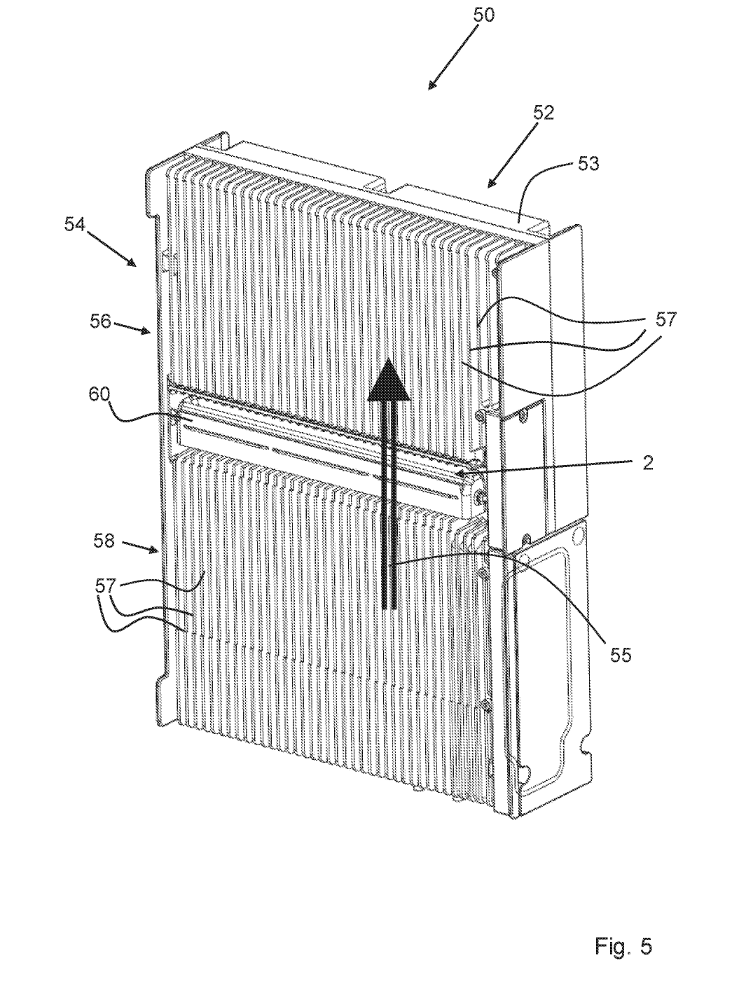

FIG. 5 Illustrates an example of a system 50 comprising an electro hydro dynamic, EHD, apparatus 2.

The system 50 comprising heat generating electronic components 52, suitably arranged inside a housing 53. A heat sink 54 is thermally connected to the heat generating electronic components 52 and is arranged on an outside of the housing 53. The EHD apparatus 2 is an EHD apparatus according to any one of aspects and/or embodiments discussed herein. The EHD apparatus 2 is arranged to generate an airflow in a flow direction 55 along and/or through the heat sink 54. Suitably, the flow direction 55 is in an upwardly direction. Thus, natural convection at the heat sink 54 is complemented by the airflow generated by the EHD apparatus 2. In these embodiments the heat sink 54 comprises a large number of fins 57, which provide a large cooling surface to be cooled by the airflow. Thus, the EHD apparatus 2 cools the heat sink 54, which in turn conducts the heat from the heat generating electronic components 52.

The heat sink 54 comprises a first heat sink part 56 and a second heat sink part 58, and a compartment 60 for holding the EHD apparatus 2. The first heat sink part 56 is arranged above the compartment 60 and the second heat sink part 58 is arranged below the compartment 60. Thus, the EHD apparatus 2 provides a push airflow in the flow direction 55 along and/or through the first heat sink part 56 and a pull airflow along and/or through the second heat sink part 58.

The compartment 60 is open at its lower and upper sides to permit the airflow generated by the EHD apparatus 2 to pass through the compartment 60.

The EHD apparatus 2 and the compartment 60 are open in the flow direction 55 for enabling natural convection cooling of the heat sink 54. Thus, natural convection is neither obstructed by the EHD apparatus 2, nor by the compartment 60, when the EHD apparatus 2 is switched off.

The system 50 may for instance be a Remote Radio Unit, RRU, and the heat generating electronic components 52 may for instance comprise a power amplifier. The high voltage applied to the first and second electrodes of the EHD apparatus 2 may be generated by electrical components arranged inside the housing 53. Electrical conductors connect such electrical components with the first and second electrodes of the EHD apparatus 2.

The system 50 is configured for use in environments where water droplets are present, such as e.g. for outdoor use. Due to the provision of the gaps in the second electrode of the EHD apparatus 2, capillary action prevents the forming of water droplets on the second electrode, as discussed above.

Mentioned purely as an example, the EHD apparatus 2 may have a length in the first direction 8, see e.g. FIGS. 2a and 4a, of approximately 0.3 m and may be supplied with a voltage within a range of 10-15 kV. Such an EHD apparatus 2 may provide an airflow within a range of 8-12 cubic feet/minute. Such an airflow may provide a 10 W/litre air increased cooling capacity over natural convection cooling in the heat sink 54. For instance, depending on the design of the heat sink 54, a heat sink 54 may provide a natural convection cooling capacity of 30 W/litre air. With the EHD apparatus 2 switched on, the cooling capacity may be approximately 40 W/litre air.

It is to be understood that the foregoing is illustrative of various example embodiments and that the invention is defined only by the appended claims. A person skilled in the art will realize that the example embodiments may be modified, and that different features of the example embodiments may be combined to create embodiments other than those described herein, without departing from the scope of the invention, as defined by the appended claims.

For instance, and electrode element 10, 12, 13 may comprise more than one gap 18 extending in parallel with each other along the electrode element 10, 12, 13.

What is claimed is:

1. An electro hydro dynamic, EHD, apparatus (2), comprising a first electrode (4) and a second electrode (6), wherein the second electrode (6) is arranged at a predetermined distance from the first electrode (4) for generating an airflow, wherein the second electrode (6) comprises at least one electrode element (10, 12),
wherein the at least one electrode element (10, 12) comprises a gap (18) extending along a length of the at least one electrode element (10, 12) for capillary conducting water droplets along the at least one electrode element (10, 12).

2. The EHD apparatus (2) according to claim 1, wherein the at least one electrode element (10, 12) comprises a through slit (20) forming the gap (18).

3. The EHD apparatus (2) according to claim 1, wherein the at least one electrode element (10, 12) comprises two separate members (22, 22′) forming there between the gap (18).

4. The EHD apparatus (2) according to claim 1, wherein the first electrode (4) and the second electrode (6) extend along a first direction (8), and the at least one electrode element (10, 12) extends along a second direction (14) across the first direction (8), and wherein at least a portion of the gap (18) has a width in the first direction (8) within a range of 0.1-0.5 mm.

5. The EHD apparatus (2) according to claim 1, wherein the gap (18) widens towards at least one end (32) of the gap (18).

6. The EHD apparatus (2) according to claim 1, wherein the at least one electrode element (10, 12) comprises a first electrode portion (26) and a second electrode portion (28), and wherein the first and second electrode portions (26, 28) are arranged at an obtuse angle (C) to each other with a vertex (30) of the obtuse angle pointing away from the first electrode (4).

7. The EHD apparatus (2) according to claim 6, wherein the gap (18) widens towards a low end (32) of the gap (18).

8. The EHD apparatus (2) according to claim 1, wherein the first electrode (2) comprises at least one protrusion (24, 24′) extending in a direction towards the second electrode (6), setting a predetermined distance between the first and second electrodes (4, 6) for forming an electric field between the first and second electrodes (4, 6) configured to generate the airflow utilising ionised air.

9. The EHD apparatus (2) according to claim 1, wherein the second electrode comprises a first electrode element (10) and a second electrode element (12), wherein the first and second electrode elements (10, 12) are arranged with an interspace (16) there between for permitting the airflow to pass through the second electrode (6).

10. A system (50) comprising heat generating electronic components (52), a heat sink (54) thermally connected to the heat generating electronic components (52), and an electro hydro dynamic, EHD, apparatus (2) arranged to generate an airflow in a flow direction (55) along and/or through the heat sink (54), wherein the EHD apparatus includes a first electrode (4) and a second electrode (6), wherein the second electrode (6) is arranged at a predetermined distance from the first electrode (4) for generating an airflow, wherein the second electrode (6) comprises at least one electrode element (10, 12), wherein the at least one electrode element (10, 12) comprises a gap (18) extending along a length of the at least one electrode element (10, 12) for capillary conducting water droplets along the at least one electrode element (10, 12).

11. The system according to claim 10, wherein the heat sink (54) comprises a first heat sink part (56) and a second heat sink part (58), and a compartment (60) for holding the EHD apparatus (2), for providing a push airflow in the flow direction (55) along and/or through the first heat sink part (56) and a pull airflow along and/or through the second heat sink part (58).

12. The system according to claim 11, wherein the EHD apparatus (2) is open in the flow direction (55) for enabling natural convection cooling of the heat sink (54).
